(19) United States
(12) Patent Application Publication
(10) Pub. No.: US 2022/0232139 A1
(43) Pub. Date: Jul. 21, 2022

(54) TOKENS TO ACCESS APPLICATIONS FROM A MULTI-FUNCTION DEVICE SIGN-ON

(71) Applicant: Xerox Corporation, Norwalk, CT (US)

(72) Inventors: Chandra Sekhar Varma Dasaraju, Webster, NY (US); Christopher M. Villone, Macedon, NY (US)

(21) Appl. No.: 17/152,570

(22) Filed: Jan. 19, 2021

(51) Int. Cl. H04N 1/00; G06F 21/31

(52) U.S. Cl. CPC H04N 1/00854; H04N 2201/0094; G06F 21/31

(57) ABSTRACT

A method is disclosed. For example, the method executed by a processor of a multi-function device (MFD) includes receiving a request to access an application on the MFD that requires a user authentication, retrieving a token associated with the user and the application, providing the token to the application for the user authentication, and executing the application on the MFD after the user authentication is executed with the token.

The present disclosure relates generally to multi-function devices (MFDs), and relates more particularly to a method and system to use tokens to access applications from a multi-function device sign-on.

### BACKGROUND

Multi-function devices (MFDs) are used to process print jobs. An MFD can perform a variety of different functions including printing, scanning, copying, faxing, and the like.

Some MFDs may have graphical user interfaces (GUIs). The GUIs can include applications such as web browsers that can allow users to access third party applications on the MFDs. The web browsers on the GUIs are deployed in proprietary programming languages that are unique to the respective MFDs. The third party applications that are accessible on the MFDs may be modified to be compatible within the web browsers of the MFDs. Thus, users can access third party applications directly on an MFD.

The third party applications, as well as other applications stored locally on an MFD, may require a user log-in and password authentication. Thus, a user may have to authenticate on the MFD, and then perform another authentication to access an application.

### SUMMARY

According to aspects illustrated herein, there are provided a method and a non-transitory computer readable medium for authenticating a user on an application with a token accessed from an MFD. One disclosed feature of the embodiments is a method, executed by a processor of the MFD, that comprises receiving a request to access an application on the MFD that requires a user authentication, retrieving a token associated with the user and the application, providing the token to the application for the user authentication, and executing the application on the MFD after the user authentication is executed with the token.

Another disclosed feature of the embodiments is a non-transitory computer-readable medium having stored thereon a plurality of instructions, the plurality of instructions including instructions which, when executed by a processor, cause the processor to perform operations to receive a request to access an application on the MFD that requires a user authentication, retrieve a token associated with the user and the application, provide the token to the application for the user authentication, and execute the application on the MFD after the user authentication is executed with the token.

### BRIEF DESCRIPTION OF THE DRAWINGS

The teaching of the present disclosure can be readily understood by considering the following detailed description in conjunction with the accompanying drawings, in which:

FIG. 1 illustrates a block diagram of an example network of the present disclosure;

FIG. 2 illustrates a block diagram of an example MFD of the present disclosure;

FIG. 3 illustrates a flow chart of a method for generating a token for authentication of an application accessed from an MFD of the present disclosure;

FIG. 4 illustrates a flow chart of a method for authenticating a user on an application with a token accessed from an MFD of the present disclosure; and

FIG. 5 illustrates a high-level block diagram of an example computer suitable for use in performing the functions described herein.

To facilitate understanding, identical reference numerals have been used, where possible, to designate identical elements that are common to the figures.

### DETAILED DESCRIPTION

The present disclosure broadly discloses a system and method to use tokens to access applications from a multi-function device sign-on. As discussed above, some MFDs may have graphical user interfaces (GUIs). The GUIs can include applications such as web browsers that can allow users to access third party applications on the MFDs. The web browsers on the GUIs are deployed in proprietary programming languages that are unique to the respective MFDs. The third party applications that are accessible on the MFDs may be modified to be compatible within the web browsers of the MFDs. Thus, users can access third party applications directly on an MFD.

The third party applications, as well as other applications stored locally on an MFD, may require a user log-in and password authentication. Thus, a user may have to authenticate on the MFD, and then perform another authentication to access an application. As a result, the user may have to remember multiple passwords and log-in credentials to log into the MFD and then log into any applications that the user wants to access through the MFD. In addition, if the user is accessing multiple different applications, the user may have to perform the authentication process several different times to access the applications.

Embodiments of the present disclosure allow a user to access applications on an MFD that require authentication with a single sign-on to the MFD. In one embodiment, a user may log into the MFD with a username and password, or any other authentication process. The authentication to the MFD may allow the user to access tokens stored in a server or may identity a database that contains authentication information for third party applications associated with the user. When the user calls an application to be executed on the MFD, the MFD may present a token to the application to authenticate the user. As a result, the user may remember a single log-in and password for the MFD.

In some embodiments, the user may access the tokens from a computing device. For example, the user may connect a laptop computer to the MFD to request the tokens to access the applications on the laptop computer. Thus, the present disclosure provides an efficient way for a user to access all applications from the MFD with a single authentication on the MFD.

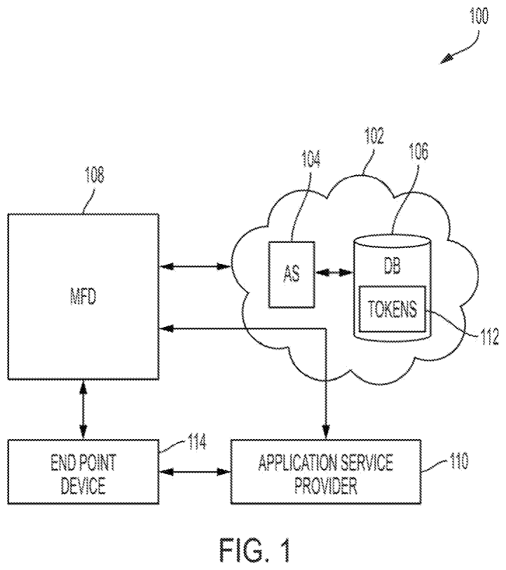

FIG. 1 illustrates an example network 100 of the present disclosure. In one embodiment, the network 100 may include an internet protocol (IP) network 102. In one embodiment, the IP network 102 may include an application server (AS) 104 and a database (DB) 106. Although a single AS 104 and single DB 106 are illustrated in FIG. 1, it should be noted that any number of application servers and databases may be deployed in the IP network 102. The AS 104 and the DB 106 may be operated by a service provider that manages the operation and maintenance of an MFD 108.

It should be noted that the IP network 102 has been simplified for ease of explanation. For example, the IP network 102 may include additional network components that are not shown. For example, the IP network 102 may include access networks, a gateway, a firewall, various network elements, and the like.

In one embodiment, the AS 104 may be communicatively coupled to the MFD 108. Although a single MFD 108 is illustrated in FIG. 1, it should be noted that any number of MFDs 108 may be deployed at various customer sites at different geographic locations.

In one embodiment, the MFD 108 may launch applications that allow a user to access files that are remotely saved, to perform additional functions on the MFD 108, and the like. The applications may include native and non-native applications. Native applications may be applications that are proprietary applications written for the MFD 108. The native applications may be written in a proprietary protocol or programming language that is understood by the operating system of the MFD 108 (e.g., extensible interface platform (EIP)). The native applications may be stored locally on the MFD 108 and users may be authenticated locally on the MFD 108.

Non-native applications may be third party applications that are written and deployed by third party application service providers. The MFD 108 may include a version of a third party application as a non-native application that is stored on the MFD 108 and written such that the MFD 108 may interact with the third party application service provider and/or a server that provides services (e.g., cloud file storage). The user may be authenticated remotely via a communication path to a server hosted by the third party application service provider.

An example of a third party application may be a cloud storage application. A user may create a cloud storage account to store files associated with the user. The user may try to access those files in the cloud storage account via a non-native cloud storage application written for the MFD 108 to access the cloud storage provided by the cloud storage service provider. The user may launch a version of the cloud storage application on the MFD 108 to connect to the cloud storage service provider and access a file directly from a user interface of the MFD 108.

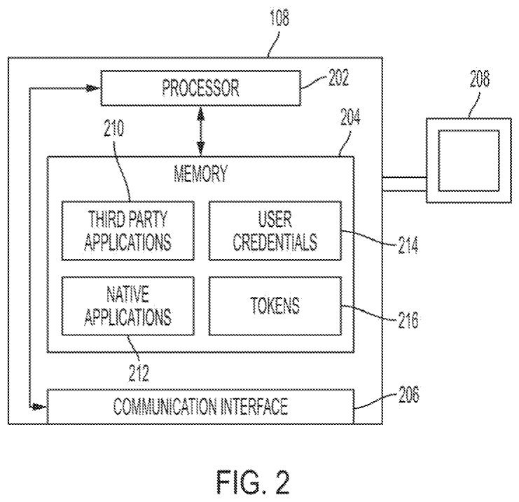

In one embodiment, the native and non-native applications may be executed via a web browser or user interface shown on a display of the MFD 108. An example of the display is illustrated in FIG. 2 and discussed in further details below.

In one embodiment, a user may be required to log into the MFD 108 with a first set of user credentials. For example, a user may provide a username and password to authenticate the user as an authorized user of the MFD 108. The user credentials may be provided via a user interface of the MFD 108, a card swipe access on the MFD 108, and the like.

After the user has logged into the MFD 108, the user may want to access one or more of the native or non-native applications. However, each application may also require an authentication process. Thus, in previous methods, a user might have to provide different usernames and passwords for each application that the user wanted to execute on the MFD 108. This may be inefficient, and some users may not remember all of their usernames and passwords for different applications.

The present disclosure allows a user to access one or more tokens 112 stored in the DB 106 via the IP network 102. For example, after the user logs into the MFD 108, the user may be authorized to obtain one or more tokens 112 from the DB 106 to perform an authentication process for an application. A token 112 may provide the user with credentials (e.g., a username and password) associated with the user to authenticate the user for an application (e.g., native and/or non-native applications).

In one embodiment, the MFD 108 may transmit a request to the AS 104 to receive a token 112. The request may include a user identification (e.g., a user's name, a user employee identification number, and the like) and information related to the application (e.g., a name of the application that the user is requesting to launch, execute, or access on the MFD 108).

In response to the request, the AS 104 may find the token 112 associated with the user and the application in the DB 106. The token 112 may be transmitted back to the MFD 108. The MFD 108 may then provide the token 112 to authenticate the user for the requested application.

In one embodiment, the application may be non-native application. As a result, the MFD 108 may run the non-native application to connect to an application service provider 110 of the non-native application. The application service provider 110 may request user credentials for access. In response, the MFD 108 may provide the token 112 to the application service provider 110. The token 112 may be used to complete an authentication process of the user. When the user has been authenticated, the application service provider 110 may allow the user to access files associated with the user's account. For example, the user may view the files on the user interface of the MFD 108 using the non-native application executed on the MFD 108 (e.g., via a web browser of the MFD 108).

In some embodiments, the token 112 may be provided to a native application. Thus, the token 112 may provide the user credentials that are entered for the authentication process executed locally on the MFD 108.

In some embodiments, after the user logs into the MFD 108, the MFD 108 may obtain all tokens 112 associated with the user. As a result, the MFD 108 may temporarily store the tokens 112 in a memory of the MFD 108. As a user selects applications to execute, the MFD 108 may quickly provide the tokens 112 to authenticate the user on the selected applications. This may allow the authentication process to occur more efficiently and eliminate additional requests to the AS 104 for additional tokens 112 each time a different application is requested. After a user logs out of the MFD 108, the tokens 112 may be deleted from the memory of the MFD 108.

In some embodiments, the present disclosure may allow a user to access the tokens 112 from an endpoint device 114. In one embodiment, the endpoint device 114 may be any type of computing device such as a desktop computer, a laptop computer, a mobile telephone, a smart phone, a tablet computer, and the like.

A user may communicatively couple the endpoint device 114 to the MFD 108. For example, the endpoint device 114 may be connected to the MFD 108 remotely via the IP network 102 or locally via a WiFi network, Bluetooth connection, and the like. The user may access the native and/or non-native applications on the MFD 108 using the endpoint device 114. For example, the screen on the endpoint device 114 may be larger and easier to read, or more convenient to use for a user than the smaller user interface of the MFD 108.

After the endpoint device 114 is communicatively coupled to the MFD 108, the endpoint device 114 may want to access the files that are stored by the application service provider 110. The user may want to select files to execute a job function on the file on the MFD 108 via the endpoint device 114. If the user cannot remember his or her username and password, the user may log into the MFD 108 through the endpoint device 114. The user may select an application to launch via the interface of the endpoint device 114. In response, the MFD 108 may obtain a token 112 from the DB 106, as described above.

In one embodiment, the token 112 may be transmitted to the application service provider 110 to authenticate the user. The user may then access the user's files held by the application service provider 110 using the user interface of the endpoint device 114.

In one embodiment, the token may be transmitted to the endpoint device 114. The endpoint device 114 may then transmit the token to the application service provider 110 to access the user's files stored by the application service provider 110.

Thus, a user may access various applications that require an authentication process using tokens 112 after a single sign-on to the MFD 108. In other words, with a single username and password that is used to log into the MFD 108, the user may be able to access various applications that require different usernames and passwords. In addition, the applications may be accessed from the MFD 108 or from an endpoint device 114 connected to the MFD 108 using the tokens 112.

FIG. 2 illustrates an example of the MFD 108 of the present disclosure. It should be noted that the MFD 108 has been simplified for ease of explanation and may include additional components that are not shown. For example, the MFD 108 may include paper trays, printheads, toner cartridges, an optical scanner, a digital front end, transport paths, finishing modules, and the like.

In one embodiment, the MFD 108 may include a processor 202, a memory 204, a communication interface 206, and a display 208. The processor 202 may be communicatively coupled to the memory 204, the communication interface 206, and the display 208. The processor 202 may execute instructions stored in the memory 204 to perform the functions described herein. The processor 202 may control operation of the communication interface 206 and the display 208.

In one embodiment, the memory 204 may be any type of non-transitory computer readable medium. For example, the memory 204 may be a random access memory (RAM), a read-only memory (RAM), a hard disk drive, a solid state drive, and the like.

In one embodiment, the memory 204 may include third party applications 210 (e.g., non-native applications), native applications 212, user credentials 214, and tokens 216. In one embodiment, the third party applications 210 may be versions of third party applications that are distributed for other devices. The third party applications 210 may be written to be understood by the operating system of the MFD 108 and to allow users to access services provided by the third party application service providers directly from the MFD 108.

In one embodiment, the native applications 212 may be applications that are written for the MFD 108 and executed locally on the MFD 108. The native applications may include proprietary applications that are created by a manufacturer or service provider of the MFD 108.

In one embodiment, the user credentials 214 may store a list of authorized users and corresponding user credentials. For example, the user credentials 214 may identify which users are allowed to access the MFD 108, associated usernames of the users, and associated passwords to authenticate the users.

In one embodiment, the tokens 216 may be the tokens 112 received from the DB 106, as described above. As noted above, the tokens 216 may be stored temporarily until the user logs off of the MFD 108. After the user logs out of the MFD 108, the tokens 216 may be deleted from the memory 204. In other words, the tokens 216 may be stored in the memory 204 temporarily while the user is logged into the MFD 108.

In one embodiment, the communication interface 206 may be a wired or wireless interface. For example, the communication interface 206 may be an Ethernet connection, a WiFi radio, a Bluetooth radio, and the like. The communication interface 206 may be used to communicatively couple the MFD 108 to the AS 104, the application service provider 110, and/or the endpoint device 114, as described above.

In one embodiment, the display 208 may provide a user interface to navigate menus and applications locally on the MFD 108. The display 208 may be a touch screen interface or may include physical buttons to navigate the user interface. The user interface may be a graphical user interface (GUI) that may launch applications within a web browser shown in the GUI.

As noted above, the user may access files via the application after using the tokens 216 to authenticate the user in the application. The user may select a file via the user interface shown on the display 208 and request a job function be executed on the file. For example, the file may be printed, emailed to another user via the MFD, and the like.

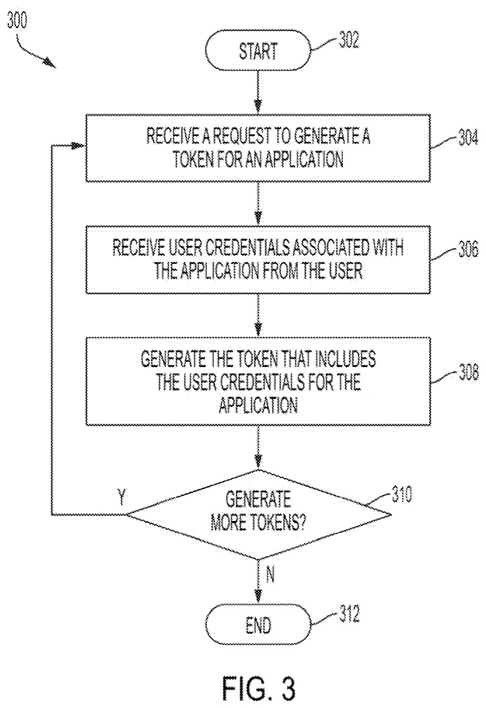

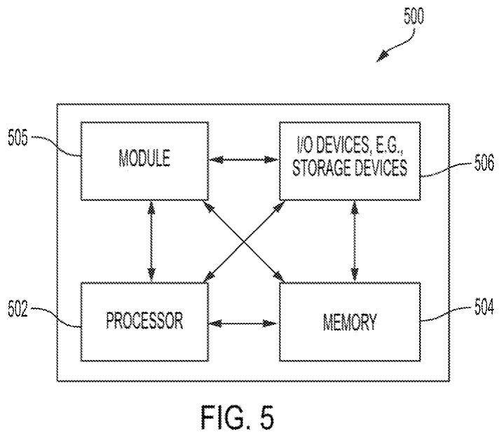

FIG. 3 a flow chart of an example method 300 for generating a token for authentication of an application accessed from an MFD of the present disclosure. In one embodiment, the method 300 may be performed by the MFD 108 or by an apparatus, such as the apparatus 500 illustrated in FIG. 5 and discussed below.

In one embodiment, the method 300 begins at block 302. At block 304, the method 300 receives a request to generate a token for an application. In one embodiment, the token may be generated via a user interface of the MFD 108 or the endpoint device 114. An application may guide a user through various steps and request the information that is used to create a token for the application.

At block 306, the method 300 receives user credentials associated with the application from the user. For example, a username and password may be provided. The username and password may be stored as part of the token that can be provided to the application to authenticate the user.

At block 308, the method 300 generates the token that includes the user credentials for the application. In one embodiment, the token may be encrypted to prevent security breaches or hacking into user's accounts with the token. The MFD may store a key that can be used to decrypt the token and then present the token to the application for authentication. Thus, even if a user were to steal the token, the user would be unable to use the token without the key stored on the MFD.

At block 310, the method 300 determines if a user would like to generate another token for another application. If the answer is yes, the method 300 returns to block 304 and the method 300 is repeated. If the answer is no, the method 300 proceeds to block 312. At block 312, the method 300 ends.

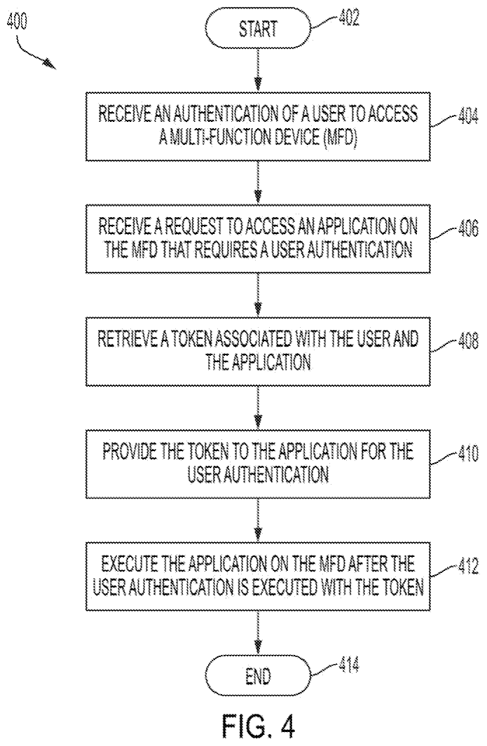

FIG. 4 illustrates a flow chart of an example method 400 for authenticating a user on an application with a token accessed from an MFD of the present disclosure. In one embodiment, the method 400 may be performed by the MFD 108 or by an apparatus, such as the apparatus 500 illustrated in FIG. 5 and discussed below.

In one embodiment, the method 400 begins at block 402. At block 404, the method 400 receives an authentication of a user to access an MFD. For example, a user may log into the MFD using a username and password, using a card swipe authentication, or any other security log-in process to access the MFD.

In some embodiments, the user may be authenticated remotely via an endpoint device of a user. As discussed above, a user may access the MFD using an endpoint device.

At block 406, the method 400 receives a request to access an application on the MFD that requires a user authentication. After the user is authenticated on the MFD, the user may access an application on the MFD. The application may be native or non-native (e.g., a third party application). The request may be received via the GUI on a display of the MFD or via an endpoint device that is connected to the MFD.

At block 408, the method 400 retrieves a token associated with the user and the application. In response to the request to access the application, the MFD may establish a connection to a token server or identity database that stores tokens associated with the user for various applications. The tokens may be generated as described above in FIG. 3.

In one embodiment, the MFD may send a request that includes a user identification and a name of the application that was requested to the token server. The token server may then find the appropriate token associated with the user identification and the name of the application and send the token back to the MFD.

In one embodiment, the MFD may obtain all of the tokens for the user after the user logs onto the MFD and before the user requests access to an application. In other words, the block 408 may be performed before the block 406 in some embodiments. As a result, the MFD may have all of the tokens associated with a user locally stored and ready to transmit to authenticate the user for any application that the user may request to access on the MFD.

At block 410, the method 400 provides the token to the application for the user authentication. In one embodiment, the application may be a non-native application or a third party application, and the MFD may connect to a server of a third party application service provider. The MFD may then provide the token to the server of the third party application server provider for authentication.

In one embodiment, the application may be a native application that is stored and executed locally on the MFD. The authentication process may also be executed locally on the MFD. The MFD may obtain the user credentials from the token and enter the user credentials from the token into the native application for user authentication.

In one embodiment, the token may be transmitted to the endpoint device that is connected to the MFD. For example, if a user connects to the MFD with an endpoint device, the token may be transmitted to the endpoint device, and the endpoint device may provide the token for authentication to the requested application.

At block 412, the method 400 executes the application on the MFD after the user authentication is executed with the token. For example, the application may be a cloud storage application that stores files associated with the user. The user may be authenticated on the cloud storage application with the token. The files may be then be displayed on the GUI of the MFD to allow a user to select a file from the cloud storage application directly from the MFD.

In one embodiment, a selection of a file from the cloud storage application may be received using a web browser shown on a display of the MFD. The user may then select a job function to be executed on the file that is selected. For example, the user may want to print the file, email the file to another user via the MFD, and the like.

In one embodiment, the blocks 406-412 may be repeated. For example, a user may request access to a second application. A second token associated with the second application may be retrieved by the MFD. The second token may be provided to the second application to authenticate the user, and the second application may be executed after the user is authenticated with the second token.

In one embodiment, after the user is done interacting with the MFD and accessing the applications via the MFD, the user may log out of the MFD. Any tokens that may have been obtained and temporarily stored in a memory of the MFD may be deleted. At block 414, the method 400 ends.

FIG. 5 depicts a high-level block diagram of a computer that is dedicated to perform the functions described herein. As depicted in FIG. 5, the computer 500 comprises one or more hardware processor elements 502 (e.g., a central processing unit (CPU), a microprocessor, or a multi-core processor), a memory 504, e.g., random access memory (RAM) and/or read only memory (ROM), a module 505 for authenticating a user on an application with a token accessed from an MFD, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computer may employ a plurality of processor elements.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 505 for authenticating a user on an application with a token accessed from an MFD (e.g., a software program comprising computer-executable instructions) can be loaded into memory 504 and executed by hardware processor element 502 to implement the steps, functions or operations as discussed above. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for authenticating a user on an application with a token accessed from an MFD (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method, comprising:
receiving, by a processor of a multi-function device (MFD), a connection to an endpoint device;
receiving, by the processor, an authentication of a user to access the MFD via the endpoint device;
receiving, by the processor, a request to access an application on the MFD that requires a user authentication from the endpoint device;
retrieving, by the processor, all tokens associated with the user for a plurality of different applications and temporarily storing the tokens in a memory of the MFD;
providing, by the processor, a token from all the tokens associated with the user and stored in the memory of the MFD to the endpoint device to allow the endpoint device to provide the token to the application for the user authentication and to allow access to the application from the endpoint device;
executing, by the processor, the application on the MFD after the user authentication is executed with the token;
receiving, by the processor, a selection of a file from the application, wherein the selection is made from the endpoint device;
executing, by the processor, a job function performed by the MFD on the file;
detecting, by the processor, the user has logged out of the MFD; and
deleting, by the processor, all the tokens associated with the user from the memory of the MFD in response to the user logging out of the MFD.

2. The method of claim 1, wherein the application comprises a third party application.

3. The method of claim 2, wherein the providing comprises:
transmitting, by the processor, the token to a server of the third party application.

4. The method of claim 1, wherein the application comprises a native application.

5. The method of claim 4, wherein the providing comprises:
entering, by the processor, user credentials from the token in the native application for the user authentication.

6. The method of claim 1, wherein the retrieving comprises:
transmitting, by the processor, a user identification and a name of the application to a token server; and
receiving, by the processor, the token associated with the user identification for the application.

7. The method of claim 1, wherein the retrieving is performed before the receiving.

8. (canceled)

9. (canceled)

10. The method of claim 1, wherein the application comprises a cloud storage application that stores files associated with the user.

11. (canceled)

12. A non-transitory computer-readable medium storing a plurality of instructions, which when executed by a processor of a multi-function device (MFD), causes the processor to perform operations, comprising:
receiving a connection to an endpoint device;
receiving an authentication of a user to access the MFD via the endpoint device;
receiving a request to access an application on the MFD that requires a user authentication from the endpoint device;
retrieving all tokens associated with the user for a plurality of different applications and temporarily storing the tokens in a memory of the MFD;
providing a token from all the tokens associated with the user and stored in the memory of the MFD to the endpoint device to allow the endpoint device to provide the token to the application for the user authentication and to allow access to the application from the endpoint device;
executing the application on the MFD after the user authentication is executed with the token;
receiving a selection of a file from the application, wherein the selection is made from the endpoint device;
executing a job function performed by the MFD on the file;
detecting the user has logged out of the MFD; and
deleting all the tokens associated with the user from the memory of the MFD in response to the user logging out of the MFD.

13. The non-transitory computer-readable medium of claim 12, wherein the application comprises a third party application.

14. The non-transitory computer-readable medium of claim 13, wherein the providing comprises:
transmitting, by the processor, the token to a server of the third party application.

15. The non-transitory computer-readable medium of claim 12, wherein the retrieving comprises:
transmitting, by the processor, a user identification and a name of the application to a token server; and
receiving, by the processor, the token associated with the user identification for the application.

16. The non-transitory computer-readable medium of claim 12, wherein the retrieving is performed before the receiving.

17. (canceled)

18. (canceled)

19. (canceled)

20. (canceled)
